(19) United States
(12) Patent Application Publication
(10) Pub. No.: US 2023/0375351 A1
(43) Pub. Date: Nov. 23, 2023

(54) SYSTEMS AND METHODS FOR PERSONALIZED SAFE DRIVING INSTRUCTIONS

(71) Applicant: Microsoft Technology Licensing, LLC, Redmond, WA (US)

(72) Inventors: Senthil Kumar PALANISAMY, Kenmore, WA (US); Antonios KARATZOGLOU, Vancouver, BC (CA)

(21) Appl. No.: 18/031,113

(22) PCT Filed: Oct. 8, 2021
(86) PCT No.: PCT/US2021/054121

§ 371 Date: Apr. 10, 2023

(30) Foreign Application Priority Data
Oct. 9, 2020 (NL) 2026649

(51) Int. Cl. G01C 21/34; G01C 21/36; G06F 18/23

(52) U.S. Cl. CPC G01C 21/3461; G01C 21/3484; G01C 21/3617; G06F 18/23

(57) ABSTRACT

A method for providing safe navigation instructions to a user includes obtaining vehicle location information from a location sensor within the vehicle; obtaining a plurality of potential routes from an initial vehicle location to a destination location, wherein the initial vehicle location is based on the vehicle location information, and wherein each potential route has corresponding route attributes; obtaining user-specific attributes of the user and population safety attributes; selecting a final route from the plurality of potential routes based on a comparison of the route attributes and the user-specific attributes and population safety attributes; and presenting the final route to the user on a presenting device within the vehicle.

### BACKGROUND

### Background and Relevant Art

Navigation software provides users seeking to reach a destination with a set of route recommendations and options from which the user may select the one that he prefers most. The selected route may depend on several criteria, such as the length of the route, whether it leads through the city or a highway, etc.

### BRIEF SUMMARY

Described herein are systems, methods, and devices for providing personalized driving instructions and routes. For example, a new driver may wish to operate the system in a safe driving mode. The safe driving mode in this example may provide navigation assistance that avoids roads where the driver would need to merge at high speeds or make left turns. The safe driving mode in this example may use local data to avoid intersections or roads that have a high accident rate. The safe driving mode may also use timing information to avoid areas that are more dangerous at that time, such as driving into the sun at sunset or driving through a high wind area during a storm. The driver or a passenger in this example may indicate other preferences, such as a desire to avoid winding or hilly roads (e.g., to prevent motion sickness which could distract the driver from safe operation of the vehicle).

In some embodiments, a method for providing safe navigation instructions to a user includes obtaining vehicle location information from a location sensor within the vehicle; obtaining a plurality of potential routes from an initial vehicle location to a destination location, wherein the initial vehicle location is based on the vehicle location information, and wherein each potential route has corresponding route attributes; obtaining user-specific attributes of the user and population safety attributes; selecting a final route from the plurality of potential routes based on a comparison of the route attributes and the user-specific attributes and population safety attributes; and presenting the final route to the user on a presenting device within the vehicle.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a navigation system, according to at least some embodiments of the present disclosure;

FIG. 2 is a flowchart illustrating a method of providing personalized safe navigation instructions to a user, according to at least some embodiments of the present disclosure; and

FIG. 3 is a schematic representation of a machine learning neural network, according to at least some embodiments of the present disclosure.

### DETAILED DESCRIPTION

The present disclosure relates generally to systems and methods for providing personalized safe driving instructions to a user. More particularly, the present disclosure relates to obtaining information about the current driver of a vehicle and, in context of available safe driving information from the similar demographics of the local population, providing personalized safe driving instructions to the user in real-time. In some embodiments, a systems and methods according to the present disclosure include comparing user-specific attributes to driver attributes of known unsafe incidents, such as single car crashes, multi-car crashes, pedestrian collisions, animal collisions, unsafe driving that did not result in a collision (e.g., speeding violations, reckless driving violations, etc.), or other unsafe driving incidents.

Systems and methods according to the present disclosure may obtain population safety attributes that includes known unsafe driving incidents and identify information about the driver and/or environment at the time of the unsafe driving incidents to predict situations in which the current user may be at an elevated risk of an unsafe driving incident. The system and/or method may then provide personalized driving instructions to route the user around or away from the predicted unsafe driving incident.

Conventional navigation instructions are calculated by identifying a fastest or shortest route between an initial location and a destination location. A conventional navigation system plots the initial vehicle location on a map of the geographic region immediately around the initial vehicle location and plots a route via the roads designated on the map to the destination. In some examples, a conventional navigation system uses archived or real-time traffic data to estimate travel speeds on roads between the initial vehicle location and the destination location to estimate and suggest the driving route with the shortest time duration. While some conventional navigation systems allow the user to input personal preferences, such as avoiding toll roads, ferries, or highways; or to avoid crowdsourced police locations to avoid speeding tickets, conventional navigation instructions are not calculated or provided to the user to predict, avoid, or prevent unsafe incidents.

The present disclosure includes examples and embodiments of input attributes related to the user and the user's vehicle that may be compared to and/or correlated to driving safety information obtained about the general population. For example, user-specific attributes may be directly compared to population safety information to match demographic information. In other examples, systems and methods according to the present disclosure may use one or more machine learning procedures to identify combinations of user-specific and/or population safety attributes that indicated an elevated risk of unsafe incidents. For example, the shortest route may route an inexperienced driver through a congested traffic area, which has an associated elevated risk of a vehicle collision. Conversely, the route which allows the highest driving speeds may present an elevate risk of speeding or other unsafe incidents to a young male, who is statistically more likely to drive at high speeds. The present disclosure can, therefore, present a number of practical applications that provide benefits and/or solve problems associated with conventional navigation systems.

In some embodiments, the population safety attributes include labels with information about the location, environment, driver, vehicle, or combinations thereof at the time of a known unsafe incident. The population safety attributes may be a test dataset that the system groups into clusters based on a correlation of labels and identified attributes. A route evaluation model can identify one or more attributes that increase or decrease the risk of an unsafe incident and determine by how much that attribute increases or decreases the risk of an unsafe incident. In particular, where certain types of training data are unknowingly underrepresented in training the machine learning system, clustering or otherwise grouping instances based on correlation of features and identified unsafe incidents may indicate specific clusters that are associated with a higher concentration of errors or inconsistences than other clusters.

In addition to identifying clusters having a higher rates of unsafe incidents, the route evaluation model may additionally identify and provide an indication of one or more attributes of the driver, environment, vehicle, location, etc. that are contributing to the unsafe driving. For example, young women may show an elevate risk of distracted driving leading to low-speed collisions, but the risk is disproportionately high on weekend evenings, indicating that distracting social behavior is of less effect during the week. Systems and methods according to the present disclosure may route such a driver through traffic-congested areas during the weekend and around those same traffic-congested areas on weekend evenings. In another example, individuals that require corrective lenses for driving may exhibit an elevated risk of unsafe incidents on poorly lit roads during rain or on otherwise wet roads. Systems and methods according to the present disclosure may route such drivers through poorly lit or unlit roads in dry weather or during daytime and on well-lit roads during wet weather at night. In yet another example, a rental agency or livery agency can set a navigation system according to the present disclosure to bias towards or only present the safest potential routes, as the safety of the driver is paramount and/or the driver is more likely to be distracted or unfamiliar with the route.

In each of the above examples, the model evaluation system can utilize the clustering information and population driving attributes to provide personalized safe driving instructions more efficiently and effectively. For example, by identifying clusters associated with a higher concentration of unsafe incidents, the route evaluation system can determine that a user having similar attributes as the identified cluster may be routed safely and efficiently without using or sampling an unnecessarily broad or robust set of training resources. Moreover, the route evaluation system can selectively train or refine discrete components of the machine learning system rather than training the entire pipeline of components that make up the machine learning system. This selective refinement and training of the machine learning system may significantly reduce utilization of processing resources as well as accomplish a higher degree of accuracy for the resulting navigation system.

In addition to generally evaluating and selecting personalized safe driving instructions, the route evaluation system can provide one or more presentations of the selected route to a user for driving or for verification. The user may receive the presentation of the selected route through one or more of visual, auditory, or haptic communication. In some embodiments, a presenting device in the vehicle includes a digital display that presents visual information such as an overview map or turn-by-turn instructions for the user to follow. In some embodiments, the presenting device in the vehicle includes a speaker that provides auditory turn-by-turn instructions to the user to follow. In some embodiments, the presenting device in the vehicle includes a haptic device that communicates turn direction information to the user by vibrating, stretching, or pulsing a surface of the steering wheel or user's seat to indicate direction information. For example, the presenting device may include a vibration motor in the user's seat to vibrate the left side of the seat cushion to inform the user a left-hand turn is approaching.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning system, model, or neural network described herein is an artificial neural network. In some embodiments, a machine learning system, model, or neural network described herein is a convolutional neural network. In some embodiments, a machine learning system, model, or neural network described herein is a recurrent neural network. In at least one embodiment, a machine learning system, model, or neural network described herein is a Bayes classifier. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

As used herein, an “instance” refers to an input object that may be provided as an input to a machine learning system to use in generating an output, such as population safety attributes. For example, an instance may refer to any record or report of an unsafe incident or any record of report of traffic movements or concentrations with or without label information. For example, an insurance record database of car accidents in a county may provide the quantity, type, location, time, environment conditions, and driver information of an unsafe incident. The insurance record database may indicate a higher frequency of car accidents in a downtown location, but when compared to the overall traffic density, the frequency relative to the number of cars may be lower than a mountain pass road. In other examples, a higher likelihood of a low speed collision downtown may be safer when compared to a more severe crash on the mountain pass.

An instance may further include other digital objects including text, identified objects, or other types of data that may be parsed and/or analyzed using one or more algorithms. In one or more embodiments described herein, an instance is a “training instance,” which refers to an instance from a collection of training instances used in training a machine learning system. Moreover, an “input instance” may refer to any instance used in implementing the machine learning system for its intended purpose. As used herein, a “training dataset” may refer to a collection of training instances.

In some embodiments, systems and methods described herein obtain a training dataset and identify one or more labels of the instances of the training dataset to predict unsafe incidents based on a comparison of user-specific attributes against population safety attributes. In some embodiments, a plurality of potential routes is evaluated for a safety score based on the user-specific attributes and population safety attributes to determine the safest personalized driving instructions. For example, systems and methods described herein may determine the safety score based on the likelihood, type, and severity of a potential unsafe incident.

In some embodiments, a lower likelihood of unsafe incident is preferable to a higher likelihood of unsafe incident. For example, a dry road may be safer than a wet road, or a straight road may be safer than a winding road. In some embodiments, the safety score is related to the type of predicted collision. For example, an animal collision may be safer than a vehicle collision, which is in turn safer than a pedestrian collision. Additionally, an animal collision with a cat is safer than an animal collision with a moose. In some embodiments, a lower speed collision is safer than a higher speed collision. For example, both the likelihood and severity of a collision is increased by higher speeds of travel. While higher speeds on a dry road may be determined to be safer than lower speeds on a wet road, higher speeds on equivalent roads and conditions will increase both the likelihood and severity of a crash.

In some embodiments, an on-road collision is safer than an off-road collision. For example, some roads, due to guard rails or walls, may contain a crash and prevent the vehicle from departing the road. In other examples, some roads lack guard rails or border rivers, canyons, cliffs, or other hazards that, during an accident, create an additional safety hazard. In at least one example, a flat, straight snow-covered road through a field is safer than a similarly flat, straight snow-covered mountain road adjacent a cliff face.

In some embodiments, a plurality of potential routes is presented to the user with a display of the associated safety score. In some embodiments, a route is selected automatically for the user without further user input (or opportunity to reject the selected route instructions). In some embodiments, the safety score is fused with other scores for the potential routes, such as duration score, efficiency score, speed score, or other personal preferences.

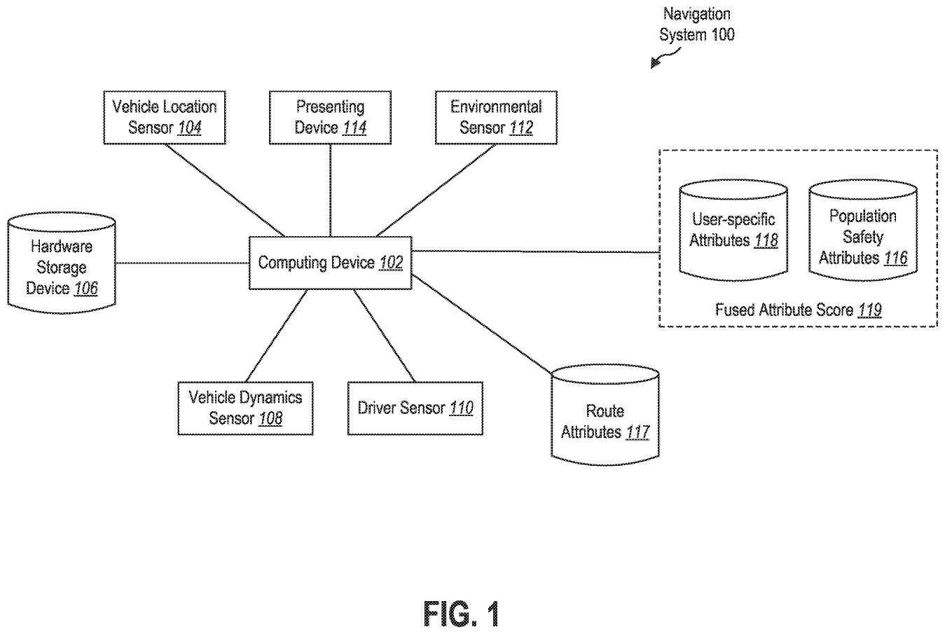

FIG. 1 is a schematic representation of a navigation system 100 according to some embodiments of the present disclosure. In some embodiments, the navigation system for providing navigation instructions in a vehicle includes a computing device 102 in communication with a location sensor 104 within a vehicle. The computing device 102 is in data communication with at least one hardware storage device 106 containing instructions that, when executed by the computing device 102, cause the computing device 102 to execute any of the methods described herein. In some embodiments, the computing device 102 is local to the vehicle, such as integrated into the vehicle or a portable device located in the vehicle. In some embodiments, the computing device 102 is a remote computing device that is located externally to the vehicle and is in communication with one or more sensors and a presentation device in the vehicle. In some embodiments, the computing device 102 is a personal electronic device, such as a smartphone that is connected to the vehicle by the user when entering the vehicle.

In some embodiments, the hardware storage device 106 is any non-transient computer readable medium that may store instructions thereon. The hardware storage device may be any type of solid-state memory; volatile memory, such as static random access memory (SRAM) or dynamic random access memory (DRAM); or non-volatile memory, such as read-only memory (ROM) including programmable ROM (PROM), erasable PROM (ERPOM) or EEPROM; magnetic storage media, such as magnetic tape; platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory, or any other non-transient storage media. In some embodiments, the hardware storage device is local to and/or integrated with the computing device. In some embodiments, the hardware storage device is accessed by the computing device through a network connection.

In some embodiments, the system includes a vehicle location sensor 104. The vehicle location sensor may be a global positioning system (GPS) sensor located in the vehicle. The GPS sensor may be in communication with the computing device via wired or wireless data connection. In some embodiments, the GPS sensor is integrated into or with the computing device. For example, the computing device may be a mobile personal computing device, such as a smartphone or tablet, with a GPS sensor therein. In other examples, the computing device is integrated into or with the vehicle and the GPS sensor is integrated into or with the vehicle. In some examples, the computing device is a mobile personal computing device and the GPS sensor is integrated into or with the vehicle, and the computing device and GPS sensor communicate via a Bluetooth connection.

In some embodiments, the vehicle location sensor 104 is a wireless radio transceiver. For example, the vehicle location may be calculated by measured connection or proximity to cellular towers or Wi-Fi networks. In some embodiments, the vehicle location sensor is a combination of the foregoing that uses a first sensor to coarsely measure vehicle location and a second sensor to refine the vehicle location.

In some embodiments, the system includes a vehicle dynamics sensor 108. The vehicle dynamics sensor is any sensor that measures the movement and/or performance of the vehicle. In some embodiments, the vehicle dynamics sensor is or includes an accelerometer, gyroscope, speedometer, tachometer, pressure sensors on the brake pedal and/or accelerator pedal, tilt sensor, wheel sensors, suspension sensors, or any other sensors. For example, the accelerometer may be used to measure either or both of longitudinal acceleration (i.e., increasing or decreasing speed) and lateral acceleration (i.e. cornering forces). The gyroscope or tilt sensors may indicate sudden movements that result in roll-over risks. The tachometer sensor may measure aggressive use of the accelerator pedal. Smooth inputs to the pedals and steering wheel tend to be safer than sudden inputs, so pressure sensors or other position sensors on pedals and/or steering wheel can assist in determining input behaviors by the driver. A wheel sensor can monitor rotational speeds of the individual wheels that may determine slippage of a wheel on the road, and a suspension sensor can monitor movement of the suspension to determine the road conditions (such as broken pavement, potholes, washboard, or grooved roads).

In some embodiments, vehicle dynamics sensors 108 can be used in combination to measure or predict additional information about the vehicle and/or driver. For example, the tachometer in combination with the accelerometer may indicate heavy accelerator pedal usage with relatively low acceleration rates, indicating the vehicle is loaded above gross vehicle weight rating or that the vehicle is towing a trailer.

In some embodiments, the vehicle is any road-based vehicle. A road-based vehicle should be understood to include vehicles that are road-legal and primarily travel over roads. For example, cars, trucks, and motorcycles should be understood to be road-based vehicles. While some road-based vehicles are capable of off-road travel to varying degrees, a navigation system according to the present disclosure utilizes road maps, on-road traffic information, and population safety attributes for on-road travel.

Referring again to FIG. 1, in some embodiments, the system includes a driver sensor 110. The driver sensor 110 can include any sensor that may measure or collect information about the driver during operation of the vehicle. Examples of driver sensors includes a facial recognition and/or tracking sensor, gaze-tracking sensor, pressure sensor in the steering wheel, a microphone, or other sensor that may monitor the driver's movement, state, or actions during operation of the vehicle. For example, a pressure sensor in the steering wheel may measure a presence of the driver's hand(s) on the steering wheel. In the case of semi- or fully self-driving vehicles, the driver may remove their hand(s) from the steering wheel, even if recommended against doing so. Removal of the driver's hands from the steering wheel delays a driver's intervention when needed, even if the driver's attention is fully on the driving of the vehicle.

Additionally, a gaze-tracking device or other attention tracking device may determine if and when the user's attention changes from the task of driving to other tasks. For example, a gaze-tracking device may measure the direction of a driver's gaze while operating the vehicle. If the driver's gaze location indicates they are not looking at the road or through the windshield, the gaze-tracking sensor may identify the driver engaging in higher risk behavior, such as being distracted by a smartphone or other in-vehicle infotainment system or falling asleep. The gaze-tracking sensor may record a lack of gaze detection indicating the driver's eyes are closed due to fatigue or distraction.

In some embodiments, the driver sensor includes a facial recognition or tracking camera. Facial recognition may allow the system to identify the driver from a plurality of driver profiles, such as from among a family of potential drivers. The user-specific attributes obtained by the system can then the be specific to the driver operating the vehicle without the driver inputting or selecting a driver profile. In some instances, young drivers may attempt to select a different driver profile to avoid supervision or monitoring, while facial recognition may eliminate an explicit selection of a driver profile. Automatic identification of the user also allows more user-specific attributes to be collected during operation of the vehicle to better predict unsafe incidents and provide safer navigation instructions to the driver. In some embodiments, rather than identifying the driver, or in accordance with determining that the driver does not have an individual profile, the driver sensor determines an age and/or gender of a driver and applies a corresponding default profile.

In some embodiments, the system includes one or more passenger sensors. For example, the system may include gaze-tracking or facial recognition for passengers in the vehicle, as the presence and/or activity of the passengers may affect or compromise the attention of the driver.

In some embodiments, the system includes an environmental sensor 112. The environmental sensor may measure or obtain environmental information surrounding the vehicle and/or along any potential routes. In some embodiments, an environmental sensor includes a thermometer, barometer, rain sensor (such as windshield-based rain sensors), light meter, compass, or other sensors that can measure or obtain the weather or environmental conditions immediately outside the vehicle. In some embodiments, the environmental sensors include communication devices, such as a radio frequency transceiver, that obtains weather information and/or road condition information for an initial or current vehicle location or for one or more locations along a potential route. For example, the weather may be below freezing, but local Department of Transportation reports indicate the road surface is dry and ice on the road surface is not a limiting factor in navigation.

Environmental information can be used to identify roads that are or will be wet, snowy, icy, dry, or even flooded during driving of potential routes. In at least one example, the environmental information may indicate that temperatures are decreasing and rain falling on a distant portion of a potential route may be snow or may produce ice on that portion of the road by the time the vehicle would reach that portion of the potential route. The system may recommend navigation instructions to avoid high elevation roads at that time, or the system may route the driver through the mountain pass earlier in the route to avoid the freezing temperatures at a later time.

In some embodiments, the system includes a presenting device 114. The presenting device can provide one or more presentations of the selected route to a user for driving or for verification. The user may receive the presentation of the selected route through one or more of visual, auditory, or haptic communication. In some embodiments, a presenting device in the vehicle includes a digital display in the center stack, the gauge cluster, or projected on the windshield that presents visual information such as an overview map or turn-by-turn instructions for the user to follow. In some embodiments, the presenting device in the vehicle includes a speaker that provides auditory turn-by-turn instructions to the user to follow. In some embodiments, the presenting device in the vehicle includes a haptic device that communicates turn direction information to the user by vibrating, stretching, or pulsing a surface of the steering wheel or user's seat to indicate direction information. For example, the presenting device may include a vibration motor in the user's seat to vibrate the left side of the seat cushion to inform the user a left-hand turn is approaching.

In some embodiments, the system includes or is in communication with an external server. The system may include a communication device that is in communication with one or more external servers. The external server(s) may have stored thereon, population safety attributes 116, route attributes 117, user-specific attributes 118, environmental information, traffic information, vehicle information, or other information that may be obtained by the computing device 102 of the system as inputs into the navigation instructions and/or into the machine learning model(s). In some embodiments, the system combines the population safety attributes 116 and the user-specific attributes 118 to create a fused attributes score 119 as will be described in more detail herein. In some embodiments, the fused attribute score 119 is created on the local computing device 102, while in some embodiments, the fused attribute score 119 is created on a remote computing device, such as a server computer.

In some embodiments, the population safety attributes 116 include any statistics or reports related to known unsafe incidents and/or to the safety of road travel. In some embodiments, the population safety attributes are obtained or collected from insurance claim data or incident reports, police reports, social media, a regional Department of Motor Vehicles, a regional Department of Transportation, the National Highway Traffic Safety Administration, or other databases. For example, the population safety attributes may include location information, driver information, vehicle information, or incident type information of the unsafe incidents. In some examples, an unsafe incident may be reported at a highway mileage marker and include a single vehicle crash due to snow-covered roads. In some examples, the population safety attributes may include a plurality of similar unsafe incidents that indicate an increased likelihood of single-vehicle crash at that same location in similar weather, but only for two-wheel drive vehicles. The system may provide alternative routes for drivers operating two-wheel drive vehicles that would otherwise be routed on that road in freezing weather. In other examples, the population safety attributes may indicate that there is a disproportionate rate of single vehicle accidents on high speed roads for drivers under the age of 20 years old and over the age of 74.

In some embodiments, the population safety attributes for unsafe incidents may be clustered or weighted depending on location and/or proximity to the vehicle. For example, the population safety attributes can include location information, such as Nation, region, state or province, city or town, or even neighborhood information. While including all unsafe incidents in the population safety attributes for a nation, the information related to unsafe incidents within a 100-mile radius of the initial vehicle location, destination location, or any location along the potential route(s). In some embodiments, the unsafe incidents of the population safety attributes can be expanded based on the location information until a minimum value and/or statistical significance of the quantity of unsafe incidents is found. For example, the population safety attributes may include a large quantity of unsafe incidents within a city for a 40-50 year-old female driver to provide statistical correlation between contributing factors for unsafe incidents, while the population safety attributes may include relatively few unsafe incidents for a 17-year-old female driver. In such examples, the system can use population safety attributes for unsafe incidents involving 17-year-old female drivers for the county, province, state, nation, or distance radius. In a particular example, a driver in Northern Maine in the United States may be better represented by including Canadian population safety attributes compared to including population safety attributes from unsafe incidents in Dade County in Florida.

In some embodiments, the population safety attributes further include time and date information of the unsafe incidents. For example, roads may be generally more congested with traffic during rush hour than the middle of the day, leading to more accidents. Conversely, because the traffic during rush hour is more predictable, as it is commuter traffic, there may be less unsafe incidents relative to the number of vehicles on the road. In another example, particular roads may be more unsafe at particular times, such as unlit roads at night or westbound roads at sunset.

In addition to location information for the unsafe incidents, the population safety attributes can, in some embodiments, include driver information, such as age, gender, driving experience (typically age relative to minimum legal driving age for that location), and/or impairments. For example, the unsafe incident reports may include the age and gender of the driver at the time of the unsafe incident, allowing the system to correlate behaviors and risks of a similar population demographic to the current driver. In at least one example, the system may identify that male drivers under the age of 20 have a statistically higher risk of high-speed crashes than female drivers under the age of 20, while female drivers under the age of 20 demonstrate a statistically higher risk of low-speed crashes than male drivers under the age of 20.

In some embodiments, the population safety attributes include impairment information related to the unsafe incidents. For example, crashes involving intoxicated drivers may be excluded from the calculations and/or from the model, as the dangers associated with drunk driving are independent of the risks associated with the potential route(s). In another example, routes that go past popular bars or clubs may be deemed less safe at night. In other examples, unsafe incidents with driver's license restrictions, such as corrective lenses, may provide stronger correlations to increased risk of crashes at night.

The population safety attributes, in some embodiments, includes general vehicle information, such as the type of vehicle or vehicle attributes, such as drivetrain, ground clearance, or tire type. The risk of crash in on a cold, snow-covered mountain road is considerably different for a four-wheel drive car with winter tires relative to a motorcycle. Conversely, the disparity decreases for a straight, flat, dry road in warm weather.

In some embodiments, the population safety attributes include severity of the unsafe incidents. The severity of known unsafe incidents may be relevant to deciding between two potential routes that are determined to have an equal or similar likelihood of an unsafe incident. However, a low-speed collision in a suburban location is preferable to a high-speed collision for all vehicles and individuals involved.

In some embodiments of systems and methods according to the present disclosure, the population safety attributes are compared to user-specific attributes 118 to make predictions of unsafe incidents along potential routes by looking at similarities between the user-specific attributes and the population safety attributes of the known unsafe incidents. For example, the user-specific attributes can include measured information from the vehicle dynamics sensor(s), the vehicle location sensor(s), the driver sensor(s), the environmental sensor(s), or combinations thereof. Additionally, the user-specific attributes can include provided information such as a driver profile including age, gender, driving experience, impairments including corrective lenses or other impairments, or personal preferences.

In some embodiments, the user-specific attributes can include real-time information measured from the vehicle dynamics sensor(s), the vehicle location sensor(s), the driver sensor(s), the environmental sensor(s), or combinations thereof. For example, the vehicle dynamics sensors may measure hard acceleration and/or braking, indicating the user is driving aggressively at that moment. This may be due to time pressures or emotions. In some embodiments, the system collects additional information to determine whether the user is angry, such as via a facial recognition camera or pressure sensors in the wheel. A hard grip of the steering wheel may further indicate the user is angry, and the route may be adjusted accordingly to calm the user. In some embodiments, a user that is in a commute and anxious about time may be more calmed by routing the user to a free-flowing highway, even if the estimate time to destination is approximately equivalent.

In some examples, the vehicle dynamics sensor may measure environmental information to determine that the exterior temperature is approaching freezing. Young drivers and/or inexperienced drivers may be routed to lower altitudes that may have warmer temperatures, main arteries of traffic that are more likely to be salted and sanded, or areas that are more likely to remain free of ice and snow. In some embodiments, older drivers and those with vision impairments may be routed away from regions prone to surface ice. In some embodiments, the vehicle dynamics sensors may indicate the road surface is of poor quality. The system may alter the route or present potential routes to avoid the poor-quality road surface.

In some embodiments, the driver sensor(s) may indicate that the user is tired or distracted, such as by use of phone, in-vehicle infotainment, or by other passengers. In such examples, a navigation system according to the present disclosure may route the user to surface roads with streetlights and intersections to keep the vehicle at a lower speed to prevent high-speed unsafe incidents.

In some embodiments, the user-specific attributes can include recorded and/or archived information measured from the vehicle dynamics sensor(s), the vehicle location sensor(s), the driver sensor(s), the environmental sensor(s), or combinations thereof. A system may monitor and record driving behavior, and in some embodiments, store such information in the driver profile. For example, a user may be a young male. Young men are statistically more prone to speeding and aggressive driving, but the current user may have a recorded history of adhering to the speed limit and proper turn signal use. In some embodiments, the driver profile may be weighted to have a greater influence on the navigation instructions and unsafe incident predictions than the correlated general driver information of the population safety attributes.

In some embodiments, the user-specific attributes include personal preferences of the user. In some embodiments, the personal preferences are stored in the driver profile. For example, the personal preferences may include a preference for rural roads or a preference for highways over surface roads. In at least one example, the driver may input a preference for navigation instructions that use highways instead of surface roads, even when the highway may extend the estimate duration of the drive. The driver may mentally and/or emotionally prefer the route in which the vehicle remains in motion to the stress of stop-and-go driving. The personal preferences may include preferences regarding one or more of: merging, left turns, roundabouts, winding roads, hills, one-way roads, lighting conditions, and the like.

In some embodiments, the personal preferences include persistent information that is used for each navigation instruction. In some embodiments, the personal preferences include trip-specific information used only for that set of navigation instructions. In some embodiments, the trip-specific information includes a trip purpose, such as “going on vacation”, “commuting to work”, or “running errands”, as the purpose of the trip can reflect or impact the mental state of the driver, as well as tolerance for detours or variations for safety purposes. In some embodiments, the trip-specific information is input explicitly by the user, while in some embodiments, the trip-specific information is determined implicitly by the system based on a selected destination. For example, inputting a law office as a destination indicates a different trip purpose than inputting a campground or movie theater as a destination.

The user-specific attributes, in some embodiments, includes vehicle information such as the type of vehicle or vehicle attributes, such as drivetrain, ground clearance, or tire type. In some examples, inexperience of a driver can be at least partially compensated for by the vehicle the user is driving. Lane-centering assists can aid an inexperienced driver with highway driving. Pedestrian detection and braking assists can aid an inexperienced or distracted driver in downtown or otherwise congested driving.

Finally, some embodiments of methods according to the present disclosure predict unsafe incidents by comparing the population safety attributes and the user-specific attributes in light of route attributes. In some embodiments, a potential route calculated by the system has associated route attributes that may make the specific user more or less likely to experience an unsafe incident, or the route attributes may uniformly increase the likelihood of an unsafe incident for any driver and vehicle on the potential route. When the route attributes are considered, a first potential route, which was previously safer than a second potential route, may be determined to be less safe than the second potential route.

In some embodiments, the route attributes include current and/or predicted road conditions. For example, a first potential route may be partially or entirely ice- or snow-covered roads while a second potential route may include less or no ice- or snow-covered roads and be safer. In some examples, all potential routes may have snow, but at least one of the potential routes may have been recently plowed. In some embodiments, the road conditions may be obtained from an external server or website, such as a local Department of Transportation website. Many Department of Transportations operate road condition reporting website that provide real-time updates of road conditions and any mitigations, such as salting, sanding, or plowing.

Road conditions can also include road surface or road surface conditions, such as construction or known damage. In some embodiments, the local Department of Transportation website includes information about work zones or other construction on the roads. In some examples, a road undergoing resurfacing may have areas of grooved road surface. Grooved road surface is more dangerous for some vehicles, such as motorcycles than for other vehicles, such as semi-trucks.

In some embodiments, the route attributes include the number of corners, turns, roundabouts, lane mergers, and/or stop lights along the road. In some embodiments, a winding road with many turns is more dangerous at night than a straight road with longer sight lines. In some embodiments, a winding road is safer during the day for drivers prone to speeding, as the densely positioned turns force the driver to travel more slowly. In some embodiments, a road with a high density of stop lights may slow an aggressive driver and render hard acceleration and braking futile, further slowing the driver. In some embodiments, the route attributes include animal information, such times and locations of probable animal activity (e.g., deer crossing).

In some embodiments, traffic density along the route can increase the likelihood of an unsafe incident. For example, dense traffic can increase the chance of the vehicle striking another vehicle and increasing the severity of any unsafe incidents that were to occur. In some examples, dense traffic can also create unsafe incidents that are out of the user's control, such as a multi-vehicle collision ahead of the driver on the road. In other examples, dense traffic can also increase exposure to other drivers on the road, who may be driving aggressively and/or dangerously. In some embodiments, a road with little traffic density can provide the driver with a more relaxing experience, further calming the driver and encouraging them to drive safely.

As described herein, the weather and road surface along the route can impact the safety of the route. Weather information at the initial vehicle location, the destination location, and along any number of points along the route can be included in the route attributes. For example, a potential route may have route attributes that indicate the initial vehicle location has fair weather and the destination location has fair weather, while a mountain pass included in the potential route has adverse weather. Another potential route may direct the user around the edge of the mountain range and, while longer in distance and duration, may not exhibit the same adverse weather and may be safer. In some embodiments, the weather information is assessed with the vehicle information to determine the safety impact. For example, a vehicle with snow tires would be safer on a snowy road than a vehicle without. As another example, a tall vehicle would be more susceptible to high winds than a vehicle with a lower center of gravity.

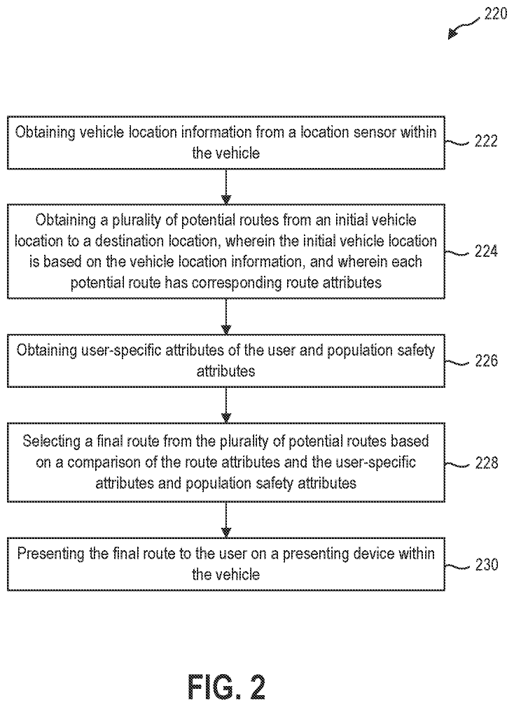

System and methods for providing safe navigation instructions according to the present disclosure can generate and/or select a safe route using rule-based models and/or machine learning systems. FIG. 2 illustrates an example of a method 220 of providing safe navigation instructions to a user. In some embodiments, the method 220 includes obtaining vehicle location information from a location sensor within the vehicle at 222 and obtaining a plurality of potential routes from an initial vehicle location to a destination location at 224. The potential routes are calculated with the initial vehicle location based on the vehicle location information. Each potential route has corresponding route attributes.

In some embodiments, the potential routes are obtained by calculating one or more the potential routes locally on the computing device. For example, the local computing device may obtain map information from a network or have map information stored locally on the hardware storage device of the local computing device. In some embodiments, the potential routes are obtained by receiving the one or more of the potential routes from a remote computing device such as a server computer. In at least one embodiments, the plurality of potential routes is obtained through a combination of receiving one or more potential routes from a remote computing device and calculating one or more potential routes locally.

The method 220 further includes obtaining user-specific attributes, such as those described in relation to FIG. 1 and elsewhere herein, and population specific attributes, such as described in relation to FIG. 1 and elsewhere herein, at 226. The method 220 includes selecting a final route from the plurality of potential routes based on a comparison of the route attributes and the user-specific attributes and population safety attributes at 228. The final route may be selected based on one or more models, as will be described in greater detail herein. The final route is presented to the user on a presenting device within the vehicle at 230.

In some embodiments, the system and method may use rule-based models to compare user-specific attributes to one or more known unsafe incidents or known high risk demographics to provide safe navigation instructions. For example, the system may include a rule-based model that states if the user is male and under the age of 24, highways and other high-speed roads increase the risk of unsafe incidents and should be avoided. In another example, a rule-based model may state that if the driver sensors indicate the driver is distracted, congested roads and roads near pedestrian centers should be avoided.

The rules of the rule-based models and the clustering of input datasets by the machine learning model can rank potential routes based on a risk factors of the potential unsafe incidents. In some embodiments, systems and methods according to the present disclosure ranks a first potential route as safer than a second potential route when the first potential route has a lower likelihood of unsafe incidents. In other examples, a chance of collision with an animal on a potential route is considered safer than an equal chance of collision with a vehicle. Additionally, a chance of collision with a vehicle on a potential route is considered safer than an equal chance of collision with a pedestrian.

In some embodiments, an unsafe incident with a higher likelihood of the vehicle exiting the road is more dangerous than an unsafe incident in which the vehicle remains on the road due to the additional hazards of the vehicle sliding or rolling when off the road. Additionally, predicted low-speed collisions are considered safer than predicted high-speed collisions. In some embodiments, the factors are combined and the relative weights of each type and location of potential unsafe incidents are compared to determine the safer potential route. For example, a low-speed collision with a vehicle may be considered safer than a high-speed collision with an animal. Further, the type of animals that frequent the roads can increase the danger of an animal collision, such as a moose versus an armadillo. Each of the risk factors may be weighted based on the risk and the associated severity.

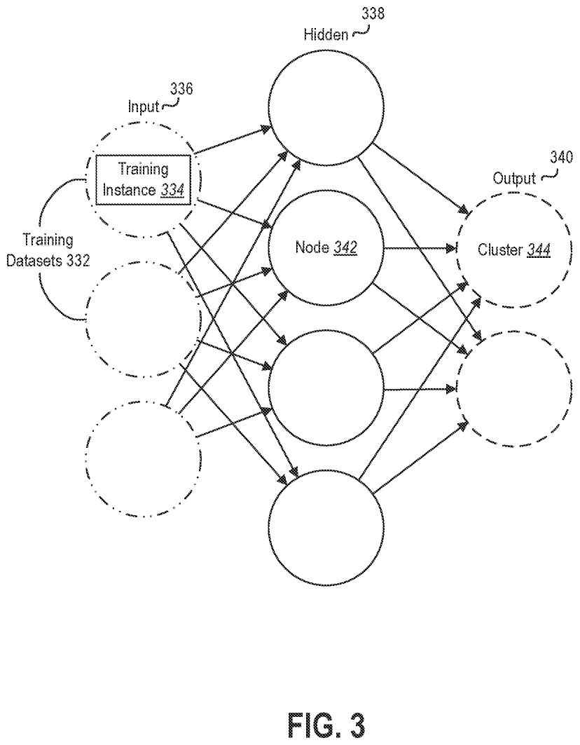

Referring now to FIG. 3, in some embodiments, systems and methods according to the present disclosure utilize one or more machine learning models to learn the likelihood of unsafe incidents for locations, weather, environmental conditions, road conditions, driver information, other available inputs, and combinations thereof. FIG. 3 is an example machine learning model 332. In some embodiments, the population safety attributes include one or more training datasets 334 including training instances 336 of known unsafe incidents. The training datasets can include a plurality of labels that allow the machine learning models to associate the presence or lack of certain labels as increasing or decreasing the probability of an unsafe incident. In some embodiments, the machine learning model can identify a severity of a training instance of the training dataset through certain labels, such as injuries to the driver or others, quantity of vehicles involved in the training instance, damage to structures or nearby objects, etc.

The machine learning system has a plurality of layers with an input layer 336 configured to receive at least one input dataset and an output layer 340, with a plurality of additional or hidden layers 338 therebetween. The training datasets can be input into the machine learning system to train the machine learning system and identify individual and combinations of labels or attributes of the training instances that contribute to or mitigate the unsafe incidents. In some embodiments, the inputs include user-specific attributes, population safety attributes, route attributes, or combinations thereof.

In some embodiments, the machine learning system can receive multiple training datasets concurrently and learn from the different training datasets simultaneously. For example, a training dataset based on insurance claims includes different information and/or labels than a police report database. In some embodiments, the machine learning system can identify common labels to associate unsafe incidents and improve the training of the system. In at least one example, a common label is a time stamp and location of an unsafe incident that is shared between the insurance claim database and the police report database. The common labels allow the machine learning system to associate the training instance from the insurance claim database with the training instance from the police report database to fuse the data from the training instances and provide additional information about the unsafe incident. The training instance from the insurance claim database may include information about the vehicle, damage to the vehicle, injuries sustained, driver experience, etc. while the training instance from the police report database may include information about the other driver, the other vehicle, weather, and road conditions. The more labels and information in the training instances, the greater number of correlations and association the machine learning system can make to improve predictions based on user-specific attributes and/or route attributes.

In some embodiments, the machine learning system includes a plurality of machine learning models that operate together. Each of the machine learning models has a plurality of hidden layers between the input layer and the output layer. The hidden layers have a plurality of nodes 342, where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters 344, to the output layer.

In some embodiments, each of the nodes 342 has a linear function and an activation function. The linear function may attempt to optimize or approximate a solution with a line of best fit. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. Supervised training allows the input of a plurality of known unsafe incidents and allows the machine learning system to develop correlations between the unsafe incidents to learn risk factors and combinations thereof. In some embodiments, at least one machine learning model uses unsupervised training. Unsupervised training can be used to draw inferences and find patterns or associations from the training dataset(s) without known unsafe incidents. For example, instances from insurance claim information may not identify fault, and an insurance claim may arise from damage to a vehicle or injury to a person that is unrelated to the driver or the vehicle itself. For example, an insurance claim instance that identifies vehicle damage from a two-vehicle accident during rush hour downtown may be a rear-ending of the driver's vehicle, however, while the driver is not at fault, such a collision may be identified as increasing the risk of an unsafe incident in a potential route for the current user. In some embodiments, unsupervised learning can identify clusters of similar labels or characteristics for a variety of training instances and allow the machine learning system to extrapolate the safety and/or risk factors of instances with similar characteristics.

In some embodiments, semi-supervised learning can combine benefits from supervised learning and unsupervised learning. As described herein, the machine learning system can identify associated labels or characteristic between instances, which may allow a training dataset with known unsafe incidents and a second training dataset including more general traffic information and reports to be fused. Unsupervised training can allow the machine learning system to cluster the instances from the second training dataset without known unsafe incidents and associate the clusters with known unsafe incidents from the first training dataset.

In some embodiments, after identifying risk factors and the interactions between risk factors, the machine learning system uses linear or non-linear regression to determine the probability of an unsafe incident along the potential route(s) calculated for the user. In some embodiments, the system determines the probability of unsafe incident by comparing the user-specific attributes to labels associated with the unsafe incidents of the population safety attributes. In some embodiments, comparing user-specific attributes to population safety attributes includes comparing the vehicle location to general vehicle locations of the unsafe incidents identified in the population safety attributes. For example, unsafe incidents with locations proximate the potential route may indicate a less safe potential route. In other examples, the safety of a first potential route may be different for a 55 mile per hour highway through a city (with on-ramps and off-ramps) versus the safety of a second potential route through a rural area with little to entering or exiting traffic.

In some embodiments, comparing user-specific attributes to population safety attributes includes comparing driver information of the user-specific attributes (i.e. a driver profile as described herein) to general driver information of the identified unsafe incidents. For example, unsafe incidents including college aged men may be less relevant to the safety of a potential route calculated for a middle-aged woman.

In some embodiments, comparing user-specific attributes to population safety attributes includes comparing the user-specific vehicle dynamics to general vehicle dynamics of the population safety attributes. For example, the vehicle dynamics of the user-specific attributes (either real-time or recorded driving history) can be compared to at least one cluster of the population safety attributes with similar general driving dynamics. Therefore, the user's demographic may be of less significance, as the user's driving behavior is used to predict unsafe incidents independent of age, gender, etc.

In some embodiments, the user-specific data lack statistical significance. For example, a driver profile for a young driver with only a few months of driving experience may lack sufficient driving history to determine whether or not the user is an aggressive driver or whether the driver is prone to distraction on weekend evenings. In such embodiments, the system may fuse the user-specific data with similar demographics from the population safety attributes. For example, while a driver profile may lack driving history for the user, other young male drivers exhibit a statistically significant increase in high-speed driving relative to other demographics. The identified characteristics of the demographic may be fused with the user-specific attributes to create a fused attribute score and impart the attributes of the demographic on the user. For example, fusing the data may include adding an average value from the population safety attributes, averaging the value from the population safety attributes with the user's associated value, or assigning the higher or lower of a value to the user's information. In at least one example, the system may approximate the user's behavior on a highway by simply assigning the average speed of a similarly young driver on highways to the user's driver profile.

In some embodiments, comparing user-specific attributes to population safety attributes includes comparing vehicle information of the user-specific attributes to general vehicle information of the population safety attributes. For example, all-wheel drive vehicles are generally safer than two-wheel drive vehicles when driving on low-friction surfaces such as snow or ice, however, there may be little safety different between all-wheel drive vehicles and two-wheel drive vehicles in dry conditions. In another example, a heavier vehicle is less safe on winding rural roads than a lighter vehicle, as the mass presents more a challenge for the user to control through successive turns.

In some embodiments, the system may identify general risk factors that are not correlated to similar attributes of the population safety attributes, but rather the risk factors are disproportionately correlated to the presence of other factors. For example, such as corrective lens requirements of the user-specific attributes may increase the probability of an unsafe incident on all dark roads, irrespective of other factors. In some embodiments, the orientation of the vehicle may present an increase risk factor, but only at certain times of day. For example, driving East during sunrise can compromise vision for any driver in any vehicle on any road. The system may route the driver on road with less exposure (i.e., cliffs or other hazards at the shoulder) to reduce the risk of a severe unsafe incident due to the limited vision from the sunrise.

The methods described herein may be performed by a client local to the vehicle, remotely via a server, or a combination of the two. In some embodiments, the local computing device in or at the vehicle can obtain the user-specific attributes and the population safety attributes, evaluate the population safety attributes, and subsequently compare the user-specific attributes to the population safety attributes as described herein to determine the driving safety of potential routes. In some embodiments, the entire process is performed at the server level with the local computing device obtaining vehicle location information and destination information, and supplying the vehicle location information and destination information to the server with any additional user-specific attributes collected or measure from the user and user's vehicle.

In some embodiments, the process is federated with some of the method occurring at the server level (e.g., the machine learning training occurs at a server level) and some at the client level (e.g., the local computing device calculates potential routes). The client can then compare the user-specific attributes and route attributes to one or more clusters identified by and obtained from the server. The driving safety of the potential routes can be determined at the client level and the potential route(s) can be presented to the user via a presenting device in the vehicle. It should be understood that while specific embodiments of systems are described herein, calculations may occur at the server, the clients, or combinations thereof. For example, in regions with limited wireless data connectivity, the client device may be unable to contact a server for information based on the population safety data. In such examples, the client device may access a local hardware storage device that contains at least a portion of the population safety data and/or the clusters identified from the population safety data.

Once the potential route(s) are identified and a driving safety score is determined based on the user-specific attributes and the population safety data, the system may present the potential route(s) to the user using the presenting device. In some embodiments, a single route may be presented to the user with the highest driving safety score. In some embodiments, a plurality of potential routes is presented to the user for the user to choose between. The plurality of potential routes may be presented with or without the associated driving safety score.

In at least one embodiment, systems and methods according to the present disclosure provide a user with navigation instructions to a selected destination that reduce the risk of unsafe incidents based on the user's driving history, the user's vehicle, obtained population safety attributes that inform the system of other drivers and vehicle's behavior, and environmental considerations.

### INDUSTRIAL APPLICABILITY

The present disclosure relates generally to systems and methods for providing personalized safe driving instructions to a user. More particularly, the present disclosure relates to obtaining information about the current driver of a vehicle and, in context of available safe driving information from the similar demographics of the local population, providing personalized safe driving instructions to the user in real-time. In some embodiments, a systems and methods according to the present disclosure include comparing user-specific attributes to driver attributes of known unsafe incidents, such as single car crashes, multi-car crashes, pedestrian collisions, animal collisions, unsafe driving that did not result in a collision (e.g., speeding violations, reckless driving violations, etc.), or other unsafe driving incidents.

Systems and methods according to the present disclosure may obtain population safety attributes that includes known unsafe driving incidents and identify information about the driver and/or environment at the time of the unsafe driving incidents to predict situations in which the current user may be at an elevated risk of an unsafe driving incident. The system and/or method may then provide personalized driving instructions to route the user around or away from the predicted unsafe driving incident.

Conventional navigation instructions are calculated by identifying a fastest or shortest route between an initial location and a destination location. A conventional navigation system plots the initial vehicle location on a map of the geographic region immediately around the initial vehicle location and plots a route via the roads designated on the map to the destination. In some examples, a conventional navigation system uses archived or real-time traffic data to estimate travel speeds on roads between the initial vehicle location and the destination location to estimate and suggest the driving route with the shortest time duration. While some conventional navigation systems allow the user to input personal preferences, such as avoiding toll roads, ferries, or highways; or to avoid crowdsourced police locations to avoid speeding tickets, conventional navigation instructions are not calculated or provided to the user to predict, avoid, or prevent unsafe incidents.

The present disclosure includes examples and embodiments of input attributes related to the user and the user's vehicle that may be compared to and/or correlated to driving safety information obtained about the general population. For example, user-specific attributes may be directly compared to population safety information to match demographic information. In other examples, systems and methods according to the present disclosure may use one or more machine learning procedures to identify combinations of user-specific and/or population safety attributes that indicated an elevated risk of unsafe incidents. For example, the shortest route may route an inexperienced driver through a congested traffic area, which has an associated elevated risk of a vehicle collision. Conversely, the route which allows the highest driving speeds may present an elevate risk of speeding or other unsafe incidents to a young male, who is statistically more likely to drive at high speeds. The present disclosure can, therefore, present a number of practical applications that provide benefits and/or solve problems associated with conventional navigation systems.

In some embodiments, the population safety attributes include labels with information about the location, environment, driver, vehicle, or combinations thereof at the time of a known unsafe incident. The population safety attributes may be a test dataset that the system groups into clusters based on a correlation of labels and identified attributes. A route evaluation model can identify one or more attributes that increase or decrease the risk of an unsafe incident and determine by how much that attribute increases or decreases the risk of an unsafe incident. In particular, where certain types of training data are unknowingly underrepresented in training the machine learning system, clustering or otherwise grouping instances based on correlation of features and identified errors may indicate specific clusters that are associated with a higher concentration of errors or inconsistences than other clusters.

In addition to identifying clusters having a higher rates of unsafe incidents, the route evaluation model may additionally identify and provide an indication of one or more attributes of the driver, environment, vehicle, location, etc. that are contributing to the unsafe driving. For example, young women may show an elevate risk of distracted driving leading to low-speed collisions, but the risk is disproportionately high on weekend evenings, indicating that distracting social behavior is of less effect during the week. Systems and methods according to the present disclosure may route such a driver through traffic-congested areas during the weekend and around those same traffic-congested areas on weekend evenings. In another example, individuals that require corrective lenses for driving may exhibit an elevated risk of unsafe incidents on poorly lit roads during rain or on otherwise wet roads. Systems and methods according to the present disclosure may route such drivers through poorly lit or unlit roads in dry weather or during daytime and on well-lit roads during wet weather at night.

In each of the above examples, the model evaluation system can utilize the clustering information and population driving attributes to provide personalized safe driving instructions more efficiently and effectively. For example, by identifying clusters associated with a higher concentration of unsafe incidents, the route evaluation system can determine that a user having similar attributes as the identified cluster may be routed safely and efficiently without using or sampling an unnecessarily broad or robust set of training resources. Moreover, the route evaluation system can selectively train or refine discrete components of the machine learning system rather than training the entire pipeline of components that make up the machine learning system. This selective refinement and training of the machine learning system may significantly reduce utilization of processing resources as well as accomplish a higher degree of accuracy for the resulting navigation system.

In addition to generally evaluating and selecting personalized safe driving instructions, the route evaluation system can provide one or more presentations of the selected route to a user for driving or for verification. The user may receive the presentation of the selected route through one or more of visual, auditory, or haptic communication. In some embodiments, a presenting device in the vehicle includes a digital display that presents visual information such as an overview map or turn-by-turn instructions for the user to follow. In some embodiments, the presenting device in the vehicle includes a speaker that provides auditory turn-by-turn instructions to the user to follow. In some embodiments, the presenting device in the vehicle includes a haptic device that communicates turn direction information to the user by vibrating, stretching, or pulsing a surface of the steering wheel or user's seat to indicate direction information. For example, the presenting device may include a vibration motor in the user's seat to vibrate the left side of the seat cushion to inform the user a left-hand turn is approaching.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning system, model, or neural network described herein is an artificial neural network. In some embodiments, a machine learning system, model, or neural network described herein is a convolutional neural network. In some embodiments, a machine learning system, model, or neural network described herein is a recurrent neural network. In at least one embodiment, a machine learning system, model, or neural network described herein is a Bayes classifier. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

As used herein, an “instance” refers to an input object that may be provided as an input to a machine learning system to use in generating an output, such as population safety attributes. For example, an instance may refer to any record or report of an unsafe incident or any record of report of traffic movements or concentrations with or without label information. For example, an insurance record database of car accidents in a county may provide the quantity, type, location, time, environment conditions, and driver information of an unsafe incident. The insurance record database may indicate a higher frequency of car accidents in a downtown location, but when compared to the overall traffic density, the frequency relative to the number of cars may be lower than a mountain pass road. In other examples, a higher likelihood of a low speed collision downtown may be safer when compared to a more severe crash on the mountain pass.

An instance may further include other digital objects including text, identified objects, or other types of data that may be parsed and/or analyzed using one or more algorithms. In one or more embodiments described herein, an instance is a “training instance,” which refers to an instance from a collection of training instances used in training a machine learning system. Moreover, an “input instance” may refer to any instance used in implementing the machine learning system for its intended purpose. As used herein, a “training dataset” may refer to a collection of training instances.

In some embodiments, systems and methods described herein obtain a training dataset and identify one or more labels of the instances of the training dataset to predict unsafe incidents based on a comparison of user-specific attributes against population safety attributes. In some embodiments, a plurality of potential routes is evaluated for a safety score based on the user-specific attributes and population safety attributes to determine the safest personalized driving instructions. For example, systems and methods described herein may determine the safety score based on the likelihood, type, and severity of a potential unsafe incident.

In some embodiments, a lower likelihood of unsafe incident is preferable to a higher likelihood of unsafe incident. For example, a dry road may be safer than a wet road, or a straight road may be safer than a winding road. In some embodiments, the safety score is related to the type of predicted collision. For example, an animal collision may be safer than a vehicle collision, which is in turn safer than a pedestrian collision. Additionally, an animal collision with a cat is safer than an animal collision with a moose. In some embodiments, a lower speed collision is safer than a higher speed collision. For example, both the likelihood and severity of a collision is increased by higher speeds of travel. While higher speeds on a dry road may be determined to be safer than lower speeds on a wet road, higher speeds on equivalent roads and conditions will increase both the likelihood and severity of a crash.

In some embodiments, an on-road collision is safer than an off-road collision. For example, some roads, due to guard rails or walls, may contain a crash and prevent the vehicle from departing the road. In other examples, some roads lack guard rails or border rivers, canyons, cliffs, or other hazards that, during an accident, create an additional safety hazard. In at least one example, a flat, straight snow-covered road through a field is safer than a similarly flat, straight snow-covered mountain road adjacent a cliff face.

In some embodiments, a plurality of potential routes is presented to the user with a display of the associated safety score. In some embodiments, a route is selected automatically for the user without further user input (or opportunity to reject the selected route instructions). In some embodiments, the safety score is fused with other scores for the potential routes, such as duration score, efficiency score, speed score, or other personal preferences.

In some embodiments, the navigation system for providing navigation instructions in a vehicle includes a computing device in communication with a location sensor within a vehicle. The computing device is in data communication with at least one hardware storage device containing instructions that, when executed by the computing device, cause the computing device to execute any of the methods described herein. In some embodiments, the computing device is local to the vehicle, such as integrated into the vehicle or a portable device located in the vehicle. In some embodiments, the computing device is a remote computing device that is located externally to the vehicle and is in communication with one or more sensors and a presentation device in the vehicle.

In some embodiments, the hardware storage device is any non-transient computer readable medium that may store instructions thereon. The hardware storage device may be any type of solid-state memory; volatile memory, such as static random access memory (SRAM) or dynamic random access memory (DRAM); or non-volatile memory, such as read-only memory (ROM) including programmable ROM (PROM), erasable PROM (ERPOM) or EEPROM; magnetic storage media, such as magnetic tape; platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory, or any other non-transient storage media. In some embodiments, the hardware storage device is local to and/or integrated with the computing device. In some embodiments, the hardware storage device is accessed by the computing device through a network connection.

In some embodiments, the system includes a vehicle location sensor. The vehicle location sensor may be a global positioning system (GPS) sensor located in the vehicle. The GPS sensor may be in communication with the computing device via wired or wireless data connection. In some embodiments, the GPS sensor is integrated into or with the computing device. For example, the computing device may be a mobile personal computing device, such as a smartphone or tablet, with a GPS sensor therein. In other examples, the computing device is integrated into or with the vehicle and the GPS sensor is integrated into or with the vehicle. In some examples, the computing device is a mobile personal computing device and the GPS sensor is integrated into or with the vehicle, and the computing device and GPS sensor communicate via a Bluetooth connection.

In some embodiments, the vehicle location sensor is a wireless radio transceiver. For example, the vehicle location may be calculated by measured connection or proximity to cellular towers or Wi-Fi networks. In some embodiments, the vehicle location sensor is a combination of the foregoing that uses a first sensor to coarsely measure vehicle location and a second sensor to refine the vehicle location.

In some embodiments, the system includes a vehicle dynamics sensor. The vehicle dynamics sensor is any sensor that measures the movement and/or performance of the vehicle. In some embodiments, the vehicle dynamics sensor is or includes an accelerometer, gyroscope, speedometer, tachometer, pressure sensors on the brake pedal and/or accelerator pedal, tilt sensor, wheel sensors, suspension sensors, or any other sensors. For example, the accelerometer may be used to measure either or both of longitudinal acceleration (i.e., increasing or decreasing speed) and lateral acceleration (i.e. cornering forces). The gyroscope or tilt sensors may indicate sudden movements that result in roll-over risks. The tachometer sensor may measure aggressive use of the accelerator pedal. Smooth inputs to the pedals and steering wheel tend to be safer than sudden inputs, so pressure sensors or other position sensors on pedals and/or steering wheel can assist in determining input behaviors by the driver. A wheel sensor can monitor rotational speeds of the individual wheels that may determine slippage of a wheel on the road, and a suspension sensor can monitor movement of the suspension to determine the road conditions (such as broken pavement, potholes, washboard, or grooved roads).

In some embodiments, vehicle dynamics sensors can be used in combination to measure or predict additional information about the vehicle and/or driver. For example, the tachometer in combination with the accelerometer may indicate heavy accelerator pedal usage with relatively low acceleration rates, indicating the vehicle is loaded above gross vehicle weight rating or that the vehicle is towing a trailer.

In some embodiments, the vehicle is any road-based vehicle. A road-based vehicle should be understood to include vehicles that are road-legal and primarily travel over roads. For example, cars, trucks, and motorcycles should be understood to be road-based vehicles. While some road-based vehicles are capable of off-road travel to varying degrees, a navigation system according to the present disclosure utilizes road maps, on-road traffic information, and population safety attributes for on-road travel.

In some embodiments, the system includes a driver sensor. The driver sensor can include any sensor that may measure or collect information about the driver during operation of the vehicle. Examples of driver sensors includes a facial recognition and/or tracking sensor, gaze-tracking sensor, pressure sensor in the steering wheel, a microphone, or other sensor that may monitor the driver's movement, state, or actions during operation of the vehicle. For example, a pressure sensor in the steering wheel may measure a presence of the driver's hand(s) on the steering wheel. In the case of semi- or fully self-driving vehicles, the driver may remove their hand(s) from the steering wheel, even if recommended against doing so. Removal of the driver's hands from the steering wheel delays a driver's intervention when needed, even if the driver's attention is fully on the driving of the vehicle.

Additionally, a gaze-tracking device or other attention tracking device may determine if and when the user's attention changes from the task of driving to other tasks. For example, a gaze-tracking device may measure the direction of a driver's gaze while operating the vehicle. If the driver's gaze location indicates they are not looking at the road or through the windshield, the gaze-tracking sensor may identify the driver engaging in higher risk behavior, such as being distracted by a smartphone or other in-vehicle infotainment system or falling asleep. The gaze-tracking sensor may record a lack of gaze detection indicating the driver's eyes are closed due to fatigue or distraction.

In some embodiments, the driver sensor includes a facial recognition or tracking camera. Facial recognition may allow the system to identify the driver from a plurality of driver profiles, such as from among a family of potential drivers. The user-specific attributes obtained by the system can then the be specific to the driver operating the vehicle without the driver inputting or selecting a driver profile. In some instances, young drivers may attempt to select a different driver profile to avoid supervision or monitoring, while facial recognition may eliminate an explicit selection of a driver profile. Automatic identification of the user also allows more user-specific attributes to be collected during operation of the vehicle to better predict unsafe incidents and provide safer navigation instructions to the driver. In some embodiments, the system includes one or more passenger sensors. For example, the system may include gaze-tracking or facial recognition for passengers in the vehicle, as the presence and/or activity of the passengers may affect or compromise the attention of the driver.

In some embodiments, the system includes an environmental sensor. The environmental sensor may measure or obtain environmental information surrounding the vehicle and/or along any potential routes. In some embodiments, an environmental sensor includes a thermometer, barometer, rain sensor (such as windshield-based rain sensors), light meter, compass, or other sensors that can measure or obtain the weather or environmental conditions immediately outside the vehicle. In some embodiments, the environmental sensors can include communication devices, such as a radio frequency transceiver, that can obtain weather information or road condition information for an initial or current vehicle location or for one or more locations along a potential route. For example, the weather may be below freezing, but local Department of Transportation reports indicate the road surface is dry and ice on the road surface is not a limiting factor in navigation.

Environmental information can be used to identify roads that are or will be wet, snowy, icy, dry, or even flooded during driving of potential routes. In at least one example, the environmental information may indicate that temperatures are decreasing and rain falling on a distant portion of a potential route may be snow or may produce ice on that portion of the road by the time the vehicle would reach that portion of the potential route. The system may recommend navigation instructions to avoid high elevation roads at that time, or the system may route the driver through the mountain pass earlier in the route to avoid the freezing temperatures at a later time.

In some embodiments, the system includes a presenting device. The presenting device can provide one or more presentations of the selected route to a user for driving or for verification. The user may receive the presentation of the selected route through one or more of visual, auditory, or haptic communication. In some embodiments, a presenting device in the vehicle includes a digital display in the center stack, the gauge cluster, or projected on the windshield that presents visual information such as an overview map or turn-by-turn instructions for the user to follow. In some embodiments, the presenting device in the vehicle includes a speaker that provides auditory turn-by-turn instructions to the user to follow. In some embodiments, the presenting device in the vehicle includes a haptic device that communicates turn direction information to the user by vibrating, stretching, or pulsing a surface of the steering wheel or user's seat to indicate direction information. For example, the presenting device may include a vibration motor in the user's seat to vibrate the left side of the seat cushion to inform the user a left-hand turn is approaching.

In some embodiments, the system includes or is in communication with an external server. The system may include a communication device that is in communication with an external server. The external server may have stored thereon, population safety attributes, user-specific attributes, environmental information, traffic information, vehicle information, driver profiles, or other information that may be obtained by the computing device of the system as inputs into the navigation instructions and/or into the machine learning model(s).

In some embodiments, the population safety attributes include any statistics reports related to known unsafe incidents and/or to the safety of road travel. In some embodiments, the population safety attributes are obtained or collected from insurance claim data or incident reports, police reports, social media, a regional Department of Motor Vehicles, a regional Department of Transportation, the National Highway Traffic Safety Administration, or other databases For example, the population safety attributes may include location information, driver information, vehicle information, or incident type information of the unsafe incidents. In some examples, an unsafe incident may be reported at a highway mileage marker and include a single vehicle crash due to snow-covered roads. In some examples, the population safety attributes may include a plurality of similar unsafe incidents that indicate an increased likelihood of single-vehicle crash at that same location in similar weather, but only for two-wheel drive vehicles. The system may provide alternative routes for drivers operating two-wheel drive vehicles that would otherwise be routed on that road in freezing weather. In other examples, the population safety attributes may indicate that there is a disproportionate rate of single vehicle accidents on high speed roads for drivers under the age of 20 years old and over the age of 74.

In some embodiments, the population safety attributes for unsafe incidents may be clustered or weighted depending on location and/or proximity to the vehicle. For example, the population safety attributes can include location information, such as Nation, region, state or province, city or town, or even neighborhood information. While including all unsafe incidents in the population safety attributes for a nation, the information related to unsafe incidents within a 100-mile radius of the initial vehicle location, destination location, or any location along the potential route(s). In some embodiments, the unsafe incidents of the population safety attributes can be expanded based on the location information until a minimum value and/or statistical significance of the quantity of unsafe incidents is found. For example, the population safety attributes may include a large quantity of unsafe incidents within a city for a 40-50 year-old female driver to provide statistical correlation between contributing factors for unsafe incidents, while the population safety attributes may include relatively few unsafe incidents for a 17 year-old female driver. In such examples, the system can use population safety attributes for unsafe incidents involving 17-year-old female drivers for the county, province, state, nation, or distance radius. In a particular example, a driver in Northern Maine in the United States may be better represented by including Canadian population safety attributes compared to including population safety attributes from unsafe incidents in Dade County in Florida.

In some embodiments, the population safety attributes further include time and date information of the unsafe incidents. For example, roads may be generally more congested with traffic during rush hour than the middle of the day, leading to more accidents. Conversely, because the traffic during rush hour is more predictable, as it is commuter traffic, there may be less unsafe incidents relative to the number of vehicles on the road.

In addition to location information for the unsafe incidents, the population safety attributes can, in some embodiments, include driver information, such as age, gender, driving experience (typically age relative to minimum legal driving age for that location), and/or impairments. For example, the unsafe incident reports may include the age and gender of the driver at the time of the unsafe incident, allowing the system to correlate behaviors and risks of a similar population demographic to the current driver. In at least one example, the system may identify that male drivers under the age of 20 have a statistically higher risk of high-speed crashes than female drivers under the age of 20, while female drivers under the age of 20 demonstrate a statistically higher risk of low-speed crashes than male drivers under the age of 20.

In some embodiments, the population safety attributes include impairment information related to the unsafe incidents. For example, crashes involving intoxicated drivers may be excluded from the calculations and/or from the model, as the dangers associated with drunk driving are independent of the risks associated with the potential route(s). In other examples, unsafe incidents with driver's license restrictions, such as corrective lenses, may provide stronger correlations to increased risk of crashes at night.

The population safety attributes, in some embodiments, includes general vehicle information, such as the type of vehicle or vehicle attributes, such as drivetrain, ground clearance, or tire type. The risk of crash in on a cold, snow-covered mountain road is considerably different for a four-wheel drive car with winter tires relative to a motorcycle. Conversely, the disparity decreases for a straight, flat, dry road in warm weather.

In some embodiments, the population safety attributes include severity of the unsafe incidents. The severity of known unsafe incidents may be relevant to deciding between two potential routes that are determined to have an equal or similar likelihood of an unsafe incident. However, a low-speed collision in a suburban location is preferable to a high-speed collision for all vehicles and individuals involved.

In some embodiments of systems and methods according to the present disclosure, the population safety attributes are compared to user-specific attributes to make predictions of unsafe incidents along potential routes by looking at similarities between the user-specific attributes and the population safety attributes of the known unsafe incidents. For example, the user-specific attributes can include measured information from the vehicle dynamics sensor(s), the vehicle location sensor(s), the driver sensor(s), the environmental sensor(s), or combinations thereof. Additionally, the user-specific attributes can include provided information such as a driver profile including age, gender, driving experience, impairments including corrective lenses or other impairments, or personal preferences.

In some embodiments, the user-specific attributes can include real-time information measured from the vehicle dynamics sensor(s), the vehicle location sensor(s), the driver sensor(s), the environmental sensor(s), or combinations thereof. For example, the vehicle dynamics sensors may measure hard acceleration and/or braking, indicating the user is driving aggressively at that moment. This may be due to time pressures or emotions. In some embodiments, the system collects additional information to determine whether the user is angry, such as via a facial recognition camera or pressure sensors in the wheel. A hard grip of the steering wheel may further indicate the user is angry, and the route may be adjusted accordingly to calm the user. In some embodiments, a user that is in a commute and anxious about time may be more calmed by routing the user to a free-flowing highway, even if the estimate time to destination is approximately equivalent.

In some examples, the vehicle dynamics sensor may measure environmental information to determine that the exterior temperature is approaching freezing. Young drivers and/or inexperienced drivers may be routed to lower altitudes that may have warmer temperatures, main arteries of traffic that are more likely to be salted and sanded, or areas that are more likely to remain free of ice and snow. In some embodiments, older drivers and those with vision impairments may be routed away from regions prone to surface ice. In some embodiments, the vehicle dynamics sensors may indicate the road surface is of poor quality. The system may alter the route or present potential routes to avoid the poor-quality road surface.

In some embodiments, the driver sensor(s) may indicate that the user is tired or distracted, such as by use of phone, in-vehicle infotainment, or by other passengers. In such examples, a navigation system according to the present disclosure may route the user to surface roads with streetlights and intersections to keep the vehicle at a lower speed to prevent high-speed unsafe incidents.

In some embodiments, the user-specific attributes can include recorded and/or archived information measured from the vehicle dynamics sensor(s), the vehicle location sensor(s), the driver sensor(s), the environmental sensor(s), or combinations thereof. A system may monitor and record driving behavior, and in some embodiments, store such information in the driver profile. For example, a user may be a young male. Young men are statistically more prone to speeding and aggressive driving, but the current user may have a recorded history of adhering to the speed limit and proper turn signal use. In some embodiments, the driver profile may be weighted to have a greater influence on the navigation instructions and unsafe incident predictions than the correlated general driver information of the population safety attributes.

In some embodiments, the user-specific attributes include personal preferences of the user. In some embodiments, the personal preferences are stored in the driver profile. For example, the personal preferences may include a preference for rural roads or a preference for highways over surface roads. In at least one example, the driver may input a preference for navigation instructions that use highways instead of surface roads, even when the highway may extend the estimate duration of the drive. The driver may mentally and/or emotionally prefer the route in which the vehicle remains in motion to the stress of stop-and-go driving.

In some embodiments, the personal preferences include persistent information that is used for each navigation instruction. In some embodiments, the personal preferences include trip-specific information used only for that set of navigation instructions. In some embodiments, the trip-specific information includes a trip purpose, such as “going on vacation”, “commuting to work”, or “running errands”, as the purpose of the trip can reflect or impact the mental state of the driver, as well as tolerance for detours or variations for safety purposes. In some embodiments, the trip-specific information is input explicitly by the user, while in some embodiments, the trip-specific information is determined implicitly by the system based on a selected destination. For example, inputting a law office as a destination indicates a different trip purpose than inputting a campground or movie theater as a destination.

The user-specific attributes, in some embodiments, includes vehicle properties such as the type of vehicle or vehicle attributes, such as drivetrain, ground clearance, or tire type. In some examples, inexperience of a driver can be at least partially compensated for by the vehicle the user is driving. Lane-centering assists can aid an inexperienced driver with highway driving. Pedestrian detection and braking assists can aid an inexperienced or distracted driver in downtown or otherwise congested driving.

Finally, some embodiments of methods according to the present disclosure predict unsafe incidents by comparing the population safety attributes and the user-specific attributes in light of route attributes. In some embodiments, a potential route calculated by the system has associated route attributes that may make the specific user more or less likely to experience an unsafe incident, or the route attributes may uniformly increase the likelihood of an unsafe incident for any driver and vehicle on the potential route. When the route attributes are considered, a first potential route, which was previously safer than a second potential route, may be determined to be less safe than the second potential route.

In some embodiments, the route attributes include road conditions. For example, a first potential route may be partially or entirely ice- or snow-covered roads while a second potential route may include less or no ice- or snow-covered roads and be safer. In some examples, all potential routes may have snow, but at least one of the potential routes may have been recently plowed. In some embodiments, the road conditions may be obtained from an external server or website, such as a local Department of Transportation website. Many Department of Transportations operate road condition reporting website that provide real-time updates of road conditions and any mitigations, such as salting, sanding, or plowing.

Road conditions can also include road surface or road surface conditions, such as construction or known damage. In some embodiments, the local Department of Transportation website includes information about work zones or other construction on the roads. In some examples, a road undergoing resurfacing may have areas of grooved road surface. Grooved road surface is more dangerous for some vehicles, such as motorcycles than for other vehicles, such as semi-trucks.

In some embodiments, the route attributes can include the number of corners, turns, or stop lights along the road. In some embodiments, a winding road with many turns is more dangerous at night than a straight road with longer sight lines. In some embodiments, a winding road is safer during the day for drivers prone to speeding, as the densely positioned turns force the driver to travel more slowly. In some embodiments, a road with a high density of stop lights may slow an aggressive driver and render hard acceleration and braking futile, further slowing the driver.

In some embodiments, traffic density along the route can increase the likelihood of an unsafe incident. For example, dense traffic can increase the chance of the vehicle striking another vehicle and increasing the severity of any unsafe incidents that were to occur. In some examples, dense traffic can also create unsafe incidents that are out of the user's control, such as a multi-vehicle collision ahead of the driver on the road. In other examples, dense traffic can also increase exposure to other drivers on the road, who may be driving aggressively and/or dangerously. In some embodiments, a road with little traffic density can provide the driver with a more relaxing experience, further calming the driver and encouraging them to drive safely.

As described herein, the weather and road surface along the route can impact the safety of the route. Weather information at the initial vehicle location, the destination location, and along any number of points along the route can be included in the route attributes. For example, a potential route may have route attributes that indicate the initial vehicle location has fair weather and the destination location has fair weather, while a mountain pass included in the potential route has adverse weather. Another potential route may direct the user around the edge of the mountain range and, while longer in distance and duration, may not exhibit the same adverse weather and may be safer.

System and methods for providing safe navigation instructions according to the present disclosure can generate and/or select a safe route using rule-based models and/or machine learning systems. In some embodiments, the system and method may use rule-based models to compare user-specific attributes to one or more known unsafe incidents or known high risk demographics to provide safe navigation instructions. For example, the system may include a rule-based model that states if the user is male and under the age of 24, highways and other high-speed roads increase the risk of unsafe incidents and should be avoided. In another example, a rule-based model may state that if the driver sensors indicate the driver is distracted, congested roads and roads near pedestrian centers should be avoided.

The rules of the rule-based models and the clustering of input datasets by the machine learning model can rank potential routes based on a risk factors of the potential unsafe incidents. In some embodiments, systems and methods according to the present disclosure ranks a first potential route as safer than a second potential route when the first potential route has a lower likelihood of unsafe incidents. In other examples, a chance of collision with an animal on a potential route is considered safer than an equal chance of collision with a vehicle. Additionally, a chance of collision with a vehicle on a potential route is considered safer than an equal chance of collision with a pedestrian.

In some embodiments, an unsafe incident with a higher likelihood of the vehicle exiting the road is more dangerous than an unsafe incident in which the vehicle remains on the road due to the additional hazards of the vehicle sliding or rolling when off the road. Additionally, predicted low-speed collisions are considered safer than predicted high-speed collisions. In some embodiments, the factors are combined and the relative weights of each type and location of potential unsafe incidents are compared to determine the safer potential route. For example, a low-speed collision with a vehicle may be considered safer than a high-speed collision with an animal. Further, the type of animals that frequent the roads can increase the danger of an animal collision, such as a moose versus an armadillo. Each of the risk factors may be weighted based on the risk and the associated severity.

In some embodiments, systems and methods according to the present disclosure utilize one or more machine learning models to learn the likelihood of unsafe incidents for locations, weather, environmental conditions, road conditions, driver information, other available inputs, and combinations thereof. In some embodiments, the population safety attributes include one or more training datasets including training instances of known unsafe incidents. The training datasets can include a plurality of labels that allow the machine learning models to associate the presence or lack of certain labels as increasing or decreasing the probability of an unsafe incident. In some embodiments, the machine learning model can identify a severity of a training instance of the training dataset through certain labels, such as injuries to the driver or others, quantity of vehicles involved in the training instance, damage to structures or nearby objects, etc.

The machine learning system has a plurality of layers with an input layer configured to receive at least one input dataset and an output layer, with a plurality of additional or hidden layers therebetween. The training datasets can be input into the machine learning system to train the machine learning system and identify individual and combinations of labels or attributes of the training instances that contribute to or mitigate the unsafe incidents. In some embodiments, the inputs include user-specific attributes, population safety attributes, route attributes, or combinations thereof.

In some embodiments, the machine learning system can receive multiple training datasets concurrently and learn from the different training datasets simultaneously. For example, a training dataset based on insurance claims includes different information and/or labels than a police report database. In some embodiments, the machine learning system can identify common labels to associate unsafe incidents and improve the training of the system. In at least one example, a common label is a time stamp and location of an unsafe incident that is shared between the insurance claim database and the police report database. The common labels allow the machine learning system to associate the training instance from the insurance claim database with the training instance from the police report database to fuse the data from the training instances and provide additional information about the unsafe incident. The training instance from the insurance claim database may include information about the vehicle, damage to the vehicle, injuries sustained, driver experience, etc. while the training instance from the police report database may include information about the other driver, the other vehicle, weather, and road conditions. The more labels and information in the training instances, the greater number of correlations and association the machine learning system can make to improve predictions based on user-specific attributes and/or route attributes.

In some embodiments, the machine learning system includes a plurality of machine learning models that operate together. Each of the machine learning models has a plurality of hidden layers between the input layer and the output layer. The hidden layers have a plurality of nodes, where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs to the output layer.

In some embodiments, each of the nodes has a linear function and an activation function. The linear function may attempt to optimize or approximate a solution with a line of best fit. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. Supervised training allows the input of a plurality of known unsafe incidents and allows the machine learning system to develop correlations between the unsafe incidents to learn risk factors and combinations thereof. In some embodiments, at least one machine learning model uses unsupervised training. Unsupervised training can be used to draw inferences and find patterns or associations from the training dataset(s) without known unsafe incidents. For example, instances from insurance claim information may not identify fault, and an insurance claim may arise from damage to a vehicle or injury to a person that is unrelated to the driver or the vehicle itself. For example, an insurance claim instance that identifies vehicle damage from a two-vehicle accident during rush hour downtown may be a rear-ending of the driver's vehicle, however, while the driver is not at fault, such a collision may be identified as increasing the risk of an unsafe incident in a potential route for the current user. In some embodiments, unsupervised learning can identify clusters of similar labels or characteristics for a variety of training instances and allow the machine learning system to extrapolate the safety and/or risk factors of instances with similar characteristics.

In some embodiments, semi-supervised learning can combine benefits from supervised learning and unsupervised learning. As described herein, the machine learning system can identify associated labels or characteristic between instances, which may allow a training dataset with known unsafe incidents and a second training dataset including more general traffic information and reports to be fused. Unsupervised training can allow the machine learning system to cluster the instances from the second training dataset without known unsafe incidents and associate the clusters with known unsafe incidents from the first training dataset.

In some embodiments, after identifying risk factors and the interactions between risk factors, the machine learning system uses linear or non-linear regression to determine the probability of an unsafe incident along the potential route(s) calculated for the user. In some embodiments, the system determines the probability of unsafe incident by comparing the user-specific attributes to labels associated with the unsafe incidents of the population safety attributes. In some embodiments, comparing user-specific attributes to population safety attributes includes comparing the vehicle location to general vehicle locations of the unsafe incidents identified in the population safety attributes. For example, unsafe incidents with locations proximate the potential route may indicate a less safe potential route. In other examples, the safety of a first potential route may be different for a 55 mile per hour highway through a city (with on-ramps and off-ramps) versus the safety of a second potential route through a rural area with little to entering or exiting traffic.

In some embodiments, comparing user-specific attributes to population safety attributes includes comparing driver information of the user-specific attributes (i.e. a driver profile as described herein) to general driver information of the identified unsafe incidents. For example, unsafe incidents including college aged men may be less relevant to the safety of a potential route calculated for a middle-aged woman.

In some embodiments, comparing user-specific attributes to population safety attributes includes comparing the user-specific vehicle dynamics to general vehicle dynamics of the population safety attributes. For example, the vehicle dynamics of the user-specific attributes (either real-time or recorded driving history) can be compared to at least one cluster of the population safety attributes with similar general driving dynamics. Therefore, the user's demographic may be of less significance, as the user's driving behavior is used to predict unsafe incidents independent of age, gender, etc.

In some embodiments, the user-specific data lack statistical significance. For example, a driver profile for a young driver with only a few months of driving experience may lack sufficient driving history to determine whether or not the user is an aggressive driver or whether the driver is prone to distraction on weekend evenings. In such embodiments, the system may fuse the user-specific data with similar demographics from the population safety attributes. For example, while a driver profile may lack driving history for the user, other young male drivers exhibit a statistically significant increase in high-speed driving relative to other demographics. The identified characteristics of the demographic may be fused with the user-specific attributes to create a fused attribute and impart the attributes of the demographic on the user. For example, fusing the data may include adding an average value from the population safety attributes, averaging the value from the population safety attributes with the user's associated value, or assigning the higher or lower of a value to the user's information. In at least one example, the system may approximate the user's behavior on a highway by simply assigning the average speed of a similarly young driver on highways to the user's driver profile.

In some embodiments, comparing user-specific attributes to population safety attributes includes comparing vehicle information of the user-specific attributes to general vehicle information of the population safety attributes. For example, all-wheel drive vehicles are generally safer than two-wheel drive vehicles when driving on low-friction surfaces such as snow or ice, however, there may be little safety different between all-wheel drive vehicles and two-wheel drive vehicles in dry conditions. In another example, a heavier vehicle is less safe on winding rural roads than a lighter vehicle, as the mass presents more a challenge for the user to control through successive turns.

In some embodiments, the system may identify general risk factors that are not correlated to similar attributes of the population safety attributes, but rather the risk factors are disproportionately correlated to the presence of other factors. For example, such as corrective lens requirements of the user-specific attributes may increase the probability of an unsafe incident on all dark roads, irrespective of other factors. In some embodiments, the orientation of the vehicle may present an increase risk factor, but only at certain times of day. For example, driving East during sunrise can compromise vision for any driver in any vehicle on any road. The system may route the driver on road with less exposure (i.e., cliffs or other hazards at the shoulder) to reduce the risk of a severe unsafe incident due to the limited vision from the sunrise.

The methods described herein may be performed by a client local to the vehicle, remotely via a server, or a combination of the two. In some embodiments, the local computing device in or at the vehicle can obtain the user-specific attributes and the population safety attributes, evaluate the population safety attributes, and subsequently compare the user-specific attributes to the population safety attributes as described herein to determine the driving safety of potential routes. In some embodiments, the entire process is performed at the server level with the local computing device obtaining vehicle location information and destination information, and supplying the vehicle location information and destination information to the server with any additional user-specific attributes collected or measure from the user and user's vehicle.

In some embodiments, the process is federated with some of the method occurring at the server level (e.g., the machine learning training occurs at a server level) and some at the client level (e.g., the local computing device calculates potential routes). The client can then compare the user-specific attributes and route attributes to one or more clusters identified by and obtained from the server. The driving safety of the potential routes can be determined at the client level and the potential route(s) can be presented to the user via a presenting device in the vehicle. It should be understood that while specific embodiments of systems are described herein, calculations may occur at the server, the clients, or combinations thereof. For example, in regions with limited wireless data connectivity, the client device may be unable to contact a server for information based on the population safety data. In such examples, the client device may access a local hardware storage device that contains at least a portion of the population safety data and/or the clusters identified from the population safety data.

Once the potential route(s) are identified and a driving safety score is determined based on the user-specific attributes and the population safety data, the system may present the potential route(s) to the user using the presenting device. In some embodiments, a single route may be presented to the user with the highest driving safety score. In some embodiments, a plurality of potential routes is presented to the user for the user to choose between. The plurality of potential routes may be presented with or without the associated driving safety score.

In at least one embodiment, systems and methods according to the present disclosure provide a user with navigation instructions to a selected destination that reduce the risk of unsafe incidents based on the user's driving history, the user's vehicle, obtained population safety attributes that inform the system of other drivers and vehicle's behavior, and environmental considerations.

The present disclosure relates to systems and methods for providing safe driving navigation instruction to a user according to at least the examples provided in the sections below.

(A1) In one aspect, some embodiments include a method of providing safe driving navigation instruction to a user. The method is performed at a local computing device positioned in a vehicle (e.g., computing device 102). The method includes: (a) obtaining vehicle location information from a location sensor within the vehicle (e.g., vehicle location sensor 104); (b) obtaining a plurality of potential routes from an initial vehicle location to a destination location, where the initial vehicle location is based on the vehicle location information, and where each potential route has corresponding route attributes; (c) obtaining user-specific attributes of the user (e.g., attributes 118) and population safety attributes (e.g., attributes 116); (d) selecting a final route from the plurality of potential routes based on a comparison of the route attributes and the user-specific attributes and population safety attributes; and (e) presenting the final route to the user on a presenting device (e.g., device 114) within the vehicle.

(A2) In some embodiments of the method of A1, selecting a final route is further based on vehicle dynamics information (e.g., from dynamics sensor 108).

(A3) In some embodiments of the method of A1 or A2, the method further includes fusing the user-specific attributes with the population safety attributes to create a fused attribute score.

(A4) In some embodiments of the method of A3, selecting a final route is at least partially based on the fused attribute score.

(A5) In some embodiments of the method of any of A1-A4: (i) the population safety attributes have label information, and (ii) receiving the population safety attributes further includes: (a) identifying label information associated with the population safety attributes, the label information including at least general driver information, general vehicle location information, and general vehicle dynamics information; and (b) clustering the population safety attributes into a plurality of clusters.

(A6) In some embodiments of the method of A5, the population safety attributes include known unsafe incidents.

(A7) In some embodiments of the method of A5 or A7, the method further includes ranking the plurality of clusters based on driving safety.

(A8) In some embodiments of the method of any of A5-A7, the method further includes comparing the user-specific attributes to the general driver information of at least one cluster of the plurality of clusters.

(A9) In some embodiments of the method of any of A5-A8, the method further includes obtaining vehicle dynamics information (e.g., from dynamics sensor 108) and comparing the vehicle dynamics information to the general vehicle dynamics information of at least one cluster of the plurality of clusters.

(A10) In some embodiments of the method of any of A5-A9, the method further includes comparing the vehicle location information to the general vehicle location information of at least one cluster of the plurality of clusters.

(A11) In some embodiments of the method of any of A1-A10, the user-specific attributes include at least one personal driving preference.

(A12) In some embodiments of the method of any of A1-A11, the method further includes receiving vehicle information, and selecting a final route is based at least partially upon the vehicle information.

(A13) In some embodiments of the method of any of A1-A12, selecting a final route includes comparing an initial route duration to a proposed route duration and comparing an initial route safety to a proposed route safety and selecting the final route based on a change in route duration and route safety.

(A14) In some embodiments of the method of any of A1-A13, the method further includes obtaining environmental information, and selecting a final route is based at least partially upon the environmental information.

(B1) In another aspect, some embodiments include a system for providing a safe driving navigation instruction to a user. The system includes: (a) a vehicle dynamics sensor (e.g., dynamics sensor 108); (b) a vehicle location sensor (e.g., location sensor 104); (c) a presenting device (e.g., presenting device 114); and (d) a local computing device (e.g., computing device 102) in data communication with the presenting device, the vehicle dynamics sensor, and the vehicle location sensor, the computing device including a storage device having instructions stored thereon that, when executed by the computing device, cause the computing device to perform the method of any of A1-A13.

(B2) In some embodiments of the system of B1, the vehicle dynamics sensor, the vehicle location sensor, the presenting device, and the local computing device are integrated in a personal mobile computing device.

In yet another aspect, some embodiments include a computing system including one or more processors and memory coupled to the one or more processors, the memory storing one or more programs configured to be executed by the one or more processors, the one or more programs including instructions for performing any of the methods described herein (e.g., A1-A13 described above).

In yet another aspect, some embodiments include a non-transitory computer-readable storage medium storing one or more programs for execution by one or more processors of a storage device, the one or more programs including instructions for performing any of the methods described herein (e.g., A1-A13 described above).

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method of providing safe driving navigation instruction to a user, the method comprising:
at a local computing device positioned in a vehicle:
obtaining vehicle location information from a location sensor within the vehicle;
obtaining a plurality of potential routes from an initial vehicle location to a destination location, wherein the initial vehicle location is based on the vehicle location information, and wherein each potential route has corresponding route attributes;
obtaining user-specific attributes of the user and population safety attributes;
selecting a final route from the plurality of potential routes based on a comparison of the route attributes and the user-specific attributes and population safety attributes; and
presenting the final route to the user on a presenting device within the vehicle.

2. The method of claim 1, wherein selecting a final route is further based at least partially upon vehicle dynamics information.

3. The method of claim 1, further comprising fusing the user-specific attributes with the population safety attributes to create a fused attribute score.

4. The method of claim 3, wherein selecting a final route is at least partially based on the fused attribute score.

5. The method of claim 1, wherein the population safety attributes have label information, and receiving the population safety attributes further includes:
identifying label information associated with the population safety attributes, the label information including at least general driver information, general vehicle location information, and general vehicle dynamics information; and
clustering the population safety attributes into a plurality of clusters.

6. The method of claim 5, wherein the population safety attributes include known unsafe incidents.

7. The method of claim 5, further comprising ranking the plurality of clusters based on driving safety.

8. The method of claim 5, further comprising comparing the user-specific attributes to the general driver information of at least one cluster of the plurality of clusters.

9. The method of claim 5, further comprising obtaining vehicle dynamics information and comparing the vehicle dynamics information to the general vehicle dynamics information of at least one cluster of the plurality of clusters.

10. The method of claim 5, further comprising comparing the vehicle location information to the general vehicle location information of at least one cluster of the plurality of clusters.

11. The method of claim 1, wherein the user-specific attributes include at least one personal driving preference.

12. The method of claim 1, further comprising receiving vehicle information and wherein selecting a final route is based at least partially upon the vehicle information.

13. The method of claim 13, wherein selecting a final route includes comparing an initial route duration to a proposed route duration and comparing an initial route safety to a proposed route safety and selecting the final route based on a change in route duration and route safety.

14. A system for providing a safe driving navigation instruction to a user, the system comprising:
a vehicle dynamics sensor;
a vehicle location sensor;
a presenting device; and
the local computing device of claim 1 in data communication with the presenting device, the vehicle dynamics sensor, and the vehicle location sensor, the computing device including a storage device having instructions stored thereon that, when executed by the computing device, cause the computing device to perform the method of claim 1.

15. The system of claim 14, wherein the vehicle dynamics sensor, the vehicle location sensor, the presenting device, and the local computing device are integrated in a personal mobile computing device.

16. The method of claim 2, further comprising fusing the user-specific attributes with the population safety attributes to create a fused attribute score.

17. The method of claim 6, further comprising ranking the plurality of clusters based on driving safety.

18. The method of claim 7, further comprising comparing the user-specific attributes to the general driver information of at least one cluster of the plurality of clusters.

19. The method of claim 8, further comprising obtaining vehicle dynamics information and comparing the vehicle dynamics information to the general vehicle dynamics information of at least one cluster of the plurality of clusters.

20. The method of claim 9, further comprising comparing the vehicle location information to the general vehicle location information of at least one cluster of the plurality of clusters.
